(19) United States
(12) Patent Application Publication
(10) Pub. No.: US 2024/0174873 A1
(43) Pub. Date: May 30, 2024

(54) INKJET INK AND INJKET INK PRODUCTION METHOD

(71) Applicant: KYOCERA Document Solutions Inc., Osaka (JP)

(72) Inventor: Seishi OJIMA, Osaka (JP)

(73) Assignee: KYOCERA Document Solutions Inc., Osaka (JP)

(21) Appl. No.: 18/516,918

(22) Filed: Nov. 21, 2023

(30) Foreign Application Priority Data
Nov. 24, 2022 (JP) 2022-187171

(51) Int. Cl. C09D 11/322; C09D 11/104

(52) U.S. Cl. CPC C09D 11/322; C09D 11/104

(57) ABSTRACT

An inkjet ink contains pigment particles and an aqueous medium. The pigment particles contain a pigment and a resin. The resin has a mass ratio to the pigment in the pigment particles of at least 1.40 and no greater than 3.10. The resin includes a polyester resin. The inkjet ink does not contain free resin dispersed in the aqueous medium or contains the free resin at a rate to the total amount of the free resin and the resin contained in the pigment particles of greater than 0.00% by mass and no greater than 3.00% by mass.

### INCORPORATION BY REFERENCE

The present application claims priority under 35 U.S.C. § 119 to Japanese Patent Application No. 2022-187171, filed on Nov. 24, 2022. The contents of this application are incorporated herein by reference in their entirety.

### BACKGROUND

The present disclosure relates to an inkjet ink and an inkjet ink production method.

There is a demand for inkjet inks having excellent ejectability and preservation stability and capable of forming images with excellent adhesion. To meet demands such as above, an inkjet ink is proposed that contains pigment particles containing a pigment and a polyester resin.

### SUMMARY

An inkjet ink according to an aspect of the present disclosure contains pigment particles and an aqueous medium. The pigment particles contain a pigment and a resin. The resin has a mass ratio to the pigment in the pigment particles of at least 1.40 and no greater than 3.10. The resin includes a polyester resin. The inkjet ink according to the aspect of the present disclosure does not contain free resin dispersed in the aqueous medium or contains the free resin at a rate to a total amount of the free resin and the resin contained in the pigment particles of greater than 0.00% by mass and no greater than 3.00% by mass.

An inkjet ink production method according to another aspect of the present disclosure includes: mixing and kneading a pigment and a resin to obtain a kneaded product; pulverizing the kneaded product to obtain a kneaded and pulverized product; performing high-pressure emulsification treatment on the kneaded and pulverized product to obtain a dispersion; centrifugating the dispersion to obtain a precipitate; and dispersing the precipitate in an aqueous medium to obtain a pigment particle dispersion containing pigment particles. The resin includes a polyester resin. The resin has a mass ratio to the pigment in the pigment particles of at least 1.40 and no greater than 3.10.

### DETAILED DESCRIPTION

The following describes embodiments of the present disclosure. Note that in the following, measurement values for volume median diameter (D₅₀) each are a value as measured using a dynamic light scattering type particle size distribution analyzer (e.g., “ZETASIZER (registered Japanese trademark) NANO ZS”, product of Malvern Instruments Ltd.) unless otherwise stated.

Measurement values for viscosity each are a value as measured using a falling ball viscometer at 25° C. in accordance with the “Japanese Industrial Standards (JIS) Z 8803:2011” unless otherwise stated.

Measurement values for glass transition point (Tg) each are a value as measured in accordance with the “Japanese Industrial Standards (JIS) K7121-2012” using a differential scanning calorimeter (e.g., “DSC-60”, product of Seiko Instruments Inc.) unless otherwise stated. The glass transition point (Tg) corresponds to the temperature corresponding to a point of inflection (specifically, an intersection point of an extrapolated baseline and an extrapolated falling line) caused by glass transition on a heat absorption curve (vertical axis: heat flow (DSC signal), horizontal axis: temperature, heating rate: 5° C./min) plotted using the differential scanning calorimeter.

Measurement values for melting point (Tm) each are a temperature at the maximum endothermic peak on an endothermic curve (vertical axis: heat flow (DSC signal), horizontal axis: temperature) as plotted using a differential scanning calorimeter (e.g., “DSC-6220”, product of Seiko Instruments Inc.) unless otherwise state. The endothermic peak appears due to the crystallization site melting.

The term “(meth)acryl” is used as a generic term for both acryl and methacryl. One type of each component described in the present specification may be used independently, or two or more types of the component may be used in combination.

### First Embodiment: Inkjet Ink

An inkjet ink (also referred to below simply as an ink) according to a first embodiment of the present disclosure contains pigment particles and an aqueous medium. The pigment particles contain a pigment and a resin. The resin has a mass ratio to the pigment in the pigment particles of at least 1.40 and no greater than 3.10. The resin includes a polyester resin. The ink according to the present embodiment does not contain free resin dispersed in the aqueous medium or contains the free resin at a ratio to the total amount of the free resin and the resin contained in the pigment particles of greater than 0.00% by mass and no greater than 3.00% by mass.

The ink according to the present embodiment is suitable for image formation on non-permeable recording mediums. The non-permeable recording mediums are inferior in ink permeability to permeable recording mediums. The absorption amount of the aqueous medium in a non-permeable recording medium is no greater than 1.0 g/m², for example. Examples of the non-permeable recording mediums include resin-made recording mediums, metal-made recording mediums, and glass-made recording mediums. Examples of the resin-made recording mediums include resin sheets and resin films. The resin contained in the resin-made recording mediums is preferably a thermoplastic resin. Specific examples of the resin include polyethylene, polypropylene, polyvinyl chloride, and polyethylene terephthalate (PET). Examples of the resin-made recording mediums include an oriented polypropylene (OPP) film or a PET film. In image formation on a resin-made recording medium with the ink according to the present embodiment, the surface (printing surface) of the recording medium may be subjected to corona discharge treatment.

As a result of having the above features, the ink according to the present embodiment can exhibit excellent ejectability and preservation stability and can form images with excellent adhesion. The reasons thereof are inferred as follows. The ink according to the present embodiment contains pigment particles containing a pigment and a resin. The resin contained in the pigment particles functions as a binder resin. The ink according to the present embodiment, in which the pigment particles contain a relatively large amount of resin (mass ratio of the resin to the pigment is at least 1.40), can form images with excellent adhesion. In particular, the ink according to the present embodiment can form images with excellent adhesion to the non-permeable recording mediums. When the pigment particles contain an excessively large amount of the resin (e.g., at a mass ratio of the resin to the pigment of greater than 3.10) by contrast, the pigment particles readily agglomerate and the resin readily separates from the pigment particles. The resin separated from the pigment particles promotes agglomeration of the pigment particles and increases viscosity of the ink. In view of the foregoing, the ink according to the present embodiment has a mass ratio of the resin to the pigment of no greater than 3.10, and can therefore inhibit agglomeration of the pigment particles and an increase in viscosity of the ink. A known ink may contain a resin (free resin) free in an aqueous medium in addition to resin contained in pigment particles. The free resin, if in a small amount, will less affect performance of the known ink. However, the free resin, if in a large amount, will serve as a cause of an increase in viscosity of the known ink or a cause of agglomeration of the pigment particles. By contrast, the ink according to the present embodiment does not contain the free resin or contains, if any, a trace amount of the free resin (at a ratio to the total amount of the free resin and the resin contained in the pigment particles of greater than 0.00% by mass and no greater than 3.00% by mass). Therefore, the ink according to the present embodiment can inhibit agglomeration of the pigment particles and an increase in viscosity of the ink which are caused due to the presence of an excessive amount of the free resin. Thus, the ink according to the present embodiment can exhibit excellent ejectability and preservation stability. Furthermore, a coating film containing a polyester resin has excellent transparency and has a smooth surface. The ink according to the present embodiment contains a polyester resin functioning as above, and contributes therefore to excellent appearance of formed images. However, the polyester resin is difficult to form into fine particles compared to other resins. It has been therefore difficult in a known ink production method to prepare pigment particles containing a relatively large amount of a polyester resin. In view of the foregoing, the present inventor found that high-pressure emulsification treatment of a kneaded and pulverized product of a pigment and a polyester resin can facilitate preparation of pigment particles containing a relatively large amount of the polyester resin, thereby achieving completion of the ink according to the present embodiment. The ink according to the present embodiment is described below in detail.

### [Pigment Particles]

The pigment particles contain a pigment and a resin. The pigment particles include a matrix of the resin and the pigment dispersed in the matrix, for example. Preferably, the pigment particles further contain a wax.

Preferably, the pigment particles contain only the pigment and the resin or contain only the pigment, the resin, and the wax. Specifically, the total percentage content of the pigment, the resin, and the wax in the pigment particles is preferably at least 90% by mass, more preferably at least 99% by mass, and further preferably 100% by mass.

The pigment particles have a volume median diameter (D₅₀) of preferably at least 30 nm and no greater than 300 nm, and more preferably at least 70 nm and no greater than 150 nm. Setting the volume median diameter of the pigment particles to at least 30 nm and no greater than 300 nm can impart excellent ejectability to the ink of the present embodiment.

The pigment particles has a percentage content in the ink according to the present embodiment of preferably at least 7.0% by mass and no greater than 30.0% by mass, and more preferably at least 15.0% by mass and no greater than 20.0% by mass. As a result of the percentage content of the pigment particles being set to at least 7.0% by mass, the ink according to the present embodiment can easily form images with desired image density. As a result of the percentage content of the pigment particles being set to no greater than 30.0% by mass, ejectability of the ink according to the present embodiment can be optimized.

### (Pigment)

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, more specifically 15:3). Examples of the violet pigments include C.I. Pigment Violet (19, 23 or 33). Examples of the black pigments include C.I. Pigment Black (7).

The pigment has a percentage content in the pigment particles of preferably at least 20.0% by mass and no greater than 50.0% by mass, and more preferably at least 30.0% by mass and no greater than 40.0% by mass.

The percentage content of the pigment in the ink according to the present embodiment is preferably at least 2.0% by mass and no greater than 12.0% by mass, and more preferably at least 5.0% by mass and no greater than 7.0% by mass.

### (Resin)

The resin in the pigment particles includes a polyester resin. As a result of the pigment particles containing a polyester resin, the surfaces of formed images can be smooth and image quality of the formed images can be optimized compared to an ink containing another resin (e.g., styrene-(meth)acrylic resin). The resin contained in the pigment particles may contain a trace amount of another resin in addition to the polyester resin but preferably contains only the polyester resin. The polyester resin has a percentage content in the resin of preferably at least 90% by mass, more preferably at least 99% by mass, and further preferably 100% by mass.

The polyester resin may be non-crystalline polyester resin or crystalline polyester resin, but preferably non-crystalline polyester resin.

### (Polyester Resin)

The polyester resin is obtained by condensation polymerization of at least one polyhydric alcohol and at least one polybasic carboxylic acid. Examples of the polyhydric alcohol for synthesis of the polyester resin include dihydric alcohols (e.g., diol compounds and bisphenol compounds) and tri- or higher-hydric alcohols. Examples of the polybasic carboxylic acid for synthesis of the polyester resin include dibasic carboxylic acids and tri- or higher-basic carboxylic acids. Note that a polybasic carboxylic acid derivative (e.g., an anhydride of a polybasic carboxylic acid or a polybasic carboxylic acid halide) that can form an ester bond by condensation polymerization may be used in place of the polybasic carboxylic acid.

Examples of the diol compounds include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenol compounds include bisphenol A, hydrogenated bisphenol A, bisphenol A ethylene oxide adducts (e.g., polyoxyethylene(2,3)-2,2-bis(4-hydroxyphenyl)propane), and bisphenol A propylene oxide adducts.

Examples of the tri- or higher-hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the dibasic carboxylic acids include maleic acid, fumaric acid, citraconic acid, itaconic acid, glutaconic acid, phthalic acid, naphthalenedicarboxylic acid, isophthalic acid, sodium 5-sulfoisophthalate, terephthalic acid, cyclohexanedicarboxylic acid, adipic acid, sebacic acid, azelaic acid, malonic acid, succinic acid, alkylsuccinic acids (specific examples include n-butylsuccinic acid, isobutylsuccinic acid, n-octylsuccinic acid, n-dodecylsuccinic acid, and isododecylsuccinic acid), and alkenylsuccinic acids (specific examples include n-butenylsuccinic acid, isobutenylsuccinic acid, n-octenylsuccinic acid, n-dodecenylsuccinic acid, and isododecenylsuccinic acid).

Examples of the tri- or higher-basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxylpropane, 1,2,4-cyclohexanetricarboxylic acid, tetra(methylenecarboxyl)methane, 1,2,7,8-octanetetracarboxylic acid, pyromellitic acid, and empol trimer acid.

A preferable polyhydric alcohol is a bisphenol A ethylene oxide adduct, a bisphenol A propylene oxide adduct, or ethylene glycol, and a more preferable polyhydric alcohol is a mixture A or B indicated below. Examples of the bisphenol A propylene oxide adduct include polyoxypropylene-(2,3)-2,2-bis(4-hyroxyphenyl)propane. Examples of the bisphenol A ethylene oxide adduct include polyoxyethylene-(2,3)-2,2-bis(4-hydroxyphenyl)propane. Note that the numerical ranges in parentheses below indicate preferable ratios.

### (Mixture A)

Bisphenol A propylene oxide adduct (at least 5% by mol and no greater than 15% by mol),
Bisphenol A ethylene oxide adduct (at least 0% by mol and no greater than 2% by mol), and
Ethylene glycol (at least 74% by mol and no greater than 94% by mol).

### (Mixture B)

Bisphenol A propylene oxide adduct (at least 62% by mol and no greater than 82% by mol) and
Ethylene glycol (at least 18% by mol and no greater than 38% by mol).

A preferable polybasic carboxylic acid is terephthalic acid, isophthalic acid, trimellitic acid, naphthalenedicarboxylic acid, or sodium 5-sulfoisophthalate, and a more preferable polybasic carboxylic acid is a mixture C or D indicated below. Note that the numerical ranges in parentheses below indicate preferable ratios.

### (Mixture C)

Terephthalic acid (at least 50% by mol and no greater than 70% by mol),
Isophthalic acid (at least 29% by mol and no greater than 49% by mol), and
Trimellitic acid (at least 0% by mol and no greater than 2% by mol).

### (Mixture D)

Terephthalic acid (at least 40% by mol and no greater than 60% by mol),
Isophthalic acid (at least 24% by mol and no greater than 44% by mol),
Naphthalenedicarboxylic acid (at least 1% by mol and no greater than 10% by mol), and
Sodium 5-sulfoisophthalate (at least 6% by mol and no greater than 16% by mol).

The polyester resin is preferably a condensation polymer of the mixture A and the mixture C or a condensation polymer of the mixture B and the mixture D.

The polyester resin has a glass transition point of preferably at least 40° C. and no greater than 80° C., and more preferably at least 50° C. and no greater than 60° C. As a result of the polyester resin having a glass transition point of at least 40° C., the ink according to the present embodiment can have optimized preservation stability. As a result of the polyester resin having a glass transition point of no greater than 80° C., the ink according to the present embodiment can have optimized adhesion.

The resin has a mass ratio (also referred to below as mass ratio (resin/pigment)) to the pigment in the pigment particles of at least 1.40 and no greater than 3.10, preferably at least 1.60 and no greater than 2.40, and more preferably at least 1.80 and no greater than 2.00. As a result of the mass ratio of the resin to the pigment being set to at least 1.40, the ink according to the present embodiment can impart sufficient adhesion to formed images. As a result of the mass ratio of the resin to the pigment being set to no greater than 3.10, excellent ejectability and preservation stability can be imparted to the ink according to the present embodiment. Note that the mass ratio of the resin to the pigment can be measured by the method described in Examples or a method in compliance therewith.

### (Wax)

The wax inhibits agglomeration of the pigment particles to optimize ejectability and preservation stability of the ink according to the present embodiment. Furthermore, the wax imparts further excellent adhesion to images formed with the ink according to the present disclosure.

Examples of the wax include aliphatic hydrocarbon waxes, oxides of aliphatic hydrocarbon waxes, plant waxes, animal waxes, mineral waxes, waxes having a fatty acid ester as a main component, and waxes in which a fatty acid ester has been partially or fully deoxidized. A preferable wax is a wax (fatty acid ester wax) having a fatty acid ester as a main component.

Examples of the aliphatic hydrocarbon waxes include polyolefin waxes (specific examples include polyethylene wax, polypropylene wax, and polyolefin copolymer wax), microcrystalline wax, paraffin wax, and Fischer-Tropsch wax. Examples of the oxides of aliphatic hydrocarbon waxes include oxidized polyethylene waxes and block copolymers of oxidized polyethylene waxes. Examples of the plant waxes include candelilla wax, carnauba wax, Japan wax, jojoba wax, and rice wax. Examples of the animal waxes include bee wax, lanolin, and spermaceti. Examples of the mineral waxes include ozokerite, ceresin, and petrolatum. Examples of the waxes having a fatty acid ester as a main component include montanic acid ester wax and castor wax. Examples of the waxes in which a fatty acid ester has been partially or fully deoxidized include deoxidized carnauba wax.

The wax has a mass ratio (also referred to below as a mass ratio (wax/resin)) to the resin in the pigment particles of preferably at least 0.01 and no greater than 0.10, and more preferably at least 0.04 and no greater than 0.06. As a result of the mass ratio of the wax being set to at least 0.01 and no greater than 0.10, images formed with the ink according to the present embodiment can have further optimized adhesion. Note that the mass ratio of the wax to the resin can be measured by the method described in Examples or a method in compliance therewith.

### [Aqueous Medium]

The aqueous medium contained in the ink according to the present embodiment is a medium including water. The aqueous medium may function as a solvent or function as a dispersion medium. Specific examples of the aqueous medium include water and an aqueous medium containing a water-soluble organic solvent.

### (Water)

The water has a percentage content in the ink according to the present embodiment of preferably at least 25.0% by mass and no greater than 80.0% by mass, and more preferably at least 40.0% by mass and no greater than 60.0% by mass.

Examples of the water-soluble organic solvent include glycol compounds, glycol ether compounds, lactam compounds, nitrogen-containing compounds, acetate compounds, thiodiglycol, glycerin, and dimethyl sulfoxide.

Examples of the glycol compounds include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

Examples of the glycol ether compounds include diethylene glycol diethyl ether (diethyl diglycol), diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

The water-soluble organic solvent is preferably a glycol compound, and more preferably ethylene glycol or diethyl glycol.

The water-soluble organic solvent has a percentage content in the ink according to the present embodiment of preferably at least 15.0% by mass and no greater than 50.0% by mass, and more preferably at least 30.0% by mass and no greater than 40.0% by mass.

The percentage content of the ethylene glycol in the ink according to the present embodiment is preferably at least 5.0% by mass and no greater than 40.0% by mass, and more preferably at least 15.0% by mass and no greater than 25.0% by mass.

The percentage content of the diethyl glycol in the ink according to the present embodiment is preferably at least 3.0% by mass and no greater than 30.0% by mass, and more preferably at least 10.0% by mass and no greater than 20.0% by mass.

Preferably, the ink according to the present embodiment contains, as the aqueous medium, only water, ethylene glycol, and diethyl glycol. The total percentage content of the water, the ethylene glycol, and the diethyl glycol in the aqueous medium is preferably at least 90% by mass, more preferably at least 99% by mass, and further preferably 100% by mass.

### (Surfactant)

Preferably, the ink according to the present embodiment further contains a surfactant. The surfactant optimizes compatibility and dispersion stability of each component contained in the ink according to the present embodiment. Furthermore, the surfactant imparts to the ink according to the present embodiment wettability to recording mediums. The surfactant in the ink according to the present embodiment is preferably a nonionic surfactant.

Examples of the nonionic surfactant in the ink according to the present embodiment include acetylene glycol surfactants (surfactants containing an acetylene glycol compound), silicon surfactants (surfactants containing a silicone compound), and fluorine surfactants (surfactants containing a fluororesin or a fluorine-containing compound). Examples of the acetylene glycol surfactants include ethylene oxide adducts of acetylene glycol and propylene oxide adducts of acetylene glycol.

The surfactant has a percentage content in the ink according to the present embodiment of preferably at least 0.1% by mass and no greater than 2.0% by mass, and more preferably at least 0.2% by mass and no greater than 0.5% by mass.

### [Optional Component]

The ink according to the present embodiment may further contain a known additive (specific examples include a solution stabilizer, an anti-drying agent, an antioxidant, a viscosity modifier, a pH adjuster, and an antifungal agent) as necessary.

### Second Embodiment: Inkjet Ink Production Method

Next, an inkjet ink production method according to a second embodiment of the present disclosure is described. The inkjet ink production method according to the present embodiment includes: a mixing and kneading step of mixing and kneading a pigment and a resin to obtain a kneaded product; a pulverization step of pulverizing the kneaded product to obtain a kneaded and pulverized product; a high-pressure emulsification step of performing high-pressure emulsification treatment on the kneaded and pulverized product to obtain a dispersion; a centrifugation step of centrifugating the dispersion to obtain a precipitate; and a dispersion step of dispersing the precipitate in an aqueous medium to obtain a pigment particle dispersion containing pigment particles. The resin includes a polyester resin. The resin has a mass ratio to the pigment in the pigment particles of at least 1.40 and no greater than 3.10. The ink production method according to the present embodiment is suitable as a method for producing the ink according to the first embodiment. Note that the pigment, the resin, the pigment particles, the later-described surfactant, and the aqueous medium can be the same as those described in the first embodiment, and therefore description thereof is omitted.

### (Mixing and Kneading Step)

In the present step, a pigment and a resin are mixed and kneaded to obtain a kneaded product. Examples of a mixing and kneading apparatus for mixing and kneading the pigment and the resin include mixer kneaders, banbury mixer kneaders, single screw extrusion kneaders, and twin screw extrusion kneaders. The mixing and kneading apparatus is preferably a twin screw extrusion kneader.

Mixing conditions include a rotational speed of at least 1000 rpm and no greater than 3000 rpm and a mixing time of at least 1 minute and no greater than 10 minutes, for example. Kneading conditions include a shaft rotational speed of at least 100 rpm and no greater than 200 rpm and a cylinder temperature of at least 100° ° C. and no greater than 200° ° C., for example.

In the present step, the charge amount ratio of the resin to the pigment is preferably at least 1.3 and no greater than 3.8, more preferably at least 1.8 and no greater than 2.7, and further preferably at least 1.8 and no greater than 2.2.

In the present step, a wax is preferably mixed and kneaded together with the pigment and the resin. In the present step, the charge amount ratio of the wax to the resin is preferably at least 0.01 and no greater than 0.20, and more preferably at least 0.04 and no greater than 0.10.

### (Pulverization Step)

In the present step, the kneaded product obtained in the mixing and kneading step is cooled and then pulverized using a pulverizer to obtain a kneaded and pulverized product containing at least the resin and the pigment. An example of a pulverizing method is pulverization using a screen pulverizer. The resultant kneaded and pulverized product may be provided directly for the high-pressure emulsification step. Alternatively, the kneaded and pulverized product may be provided for the high-pressure emulsification step after having been further finely pulverized using a jet mill or the like and having been classified using a classifier.

### (High-pressure Emulsification Step)

In the present step, the kneaded and pulverized product obtained in the pulverization step is subjected to emulsification treatment together with an aqueous medium using a high-pressure emulsification apparatus. In the present step, the kneaded and pulverized product is further finely pulverized, thereby forming pigment particles, for example. As a result, a dispersion in which the pigment particles are dispersed in the aqueous medium is obtained. Furthermore, a basic compound (e.g., NaOH) may be added in the high-pressure emulsification treatment. Such addition can neutralize the resin contained in the kneaded and pulverized product. In addition, a surfactant may be added in high-pressure emulsification treatment in the present step.

In the present step, the emulsification temperature is preferably at least 110° C. and no greater than 180° C. The treatment pressure is preferably at least 100 MPa and no greater than 200 MPa. The number of times of the emulsification treatment performed is preferably at least 2 and no greater than 10.

### (Centrifugation Step)

In the present step, the dispersion obtained in the high-pressure emulsification step is centrifugated to obtain a precipitate including the pigment particles. Conditions for centrifugation may include a centrifugation speed of at least 3000 rpm and no greater than 10000 rpm and a centrifugation time of at least 12 minutes and no greater than 48 minutes, for example. In the present step, free resin (a component of the resin used in the mixing and kneading step that has not been incorporated into the pigment particles and that is in a solvent) remains as a supernatant without being precipitated. Therefore, the amount of the free resin in the ink formed can be reduced through the present step being carried out.

### (Dispersion Step)

In the present step, the precipitate is dispersed in an aqueous medium to obtain a pigment particle dispersion containing the pigment particles. The resultant pigment particles dispersion can be used as an ink for example through further addition of an aqueous medium for composition adjustment. Alternatively, the pigment particle dispersion can be used directly as an ink, for example. In addition, the resultant pigment particle dispersion may be subjected to for example centrifugation or filtering for removing coarse particles.

### EXAMPLES

The following described examples of the present disclosure. However, the present disclosure is not limited to the following examples.

### [Gel Filtration Chromatography (GPC)]

The mass and mass average molecular weight of each of resins were determined by gel filtration chromatography (GPC) under the following conditions.
Measuring device: “HLC-8020GPC” produced by Tosoh Corporation
Column: Ultra-high performance semi-micro SEC column (“TSKGEL SUPERMULTIPORE HZ-H”, product of Tosoh Corporation, filler: styrene-divinylbenzene resin, column size: 4.6-mm inner diameter and 15-cm length, filler particle diameter: 6 μm)
Number of columns: 3
Eluent: tetrahydrofuran
Eluent flow rate: 0.35 mL/min
Amount of sample solution: 10 μL
Column temperature: 40° ° C.
Detector: refractive index (RI) detector
Calibration curve: calibration curve plotted using n-propyl benzene and monodispersed polystyrene standard samples (F-40, F-20, F-4, F-1, A-5000, A-2500, and A-1000) produced by Tosoh Corporation

### [Measurement of Tg and Tm]

The glass transition point (Tg) and the melting point (Tm) of the following resins were measured at a heating rate of 5° C./min using a differential scanning calorimeter (“DSC-60”, product of SHIMADZU CORPORATION).

### [Preparation of Non-crystalline Polyester Resin A]

A reaction vessel equipped with a stirrer and a distillation column was charged with 60 parts by mole of terephthalic acid, 39 parts by mole of isophthalic acid, and 1 part by mole of trimellitic acid each as a polybasic carboxylic acid, 10 parts by mole of BPP, 1 part by mole of BPE, and 84 parts by mole of ethylene glycol each as a polyhydric alcohol, and tetrabutoxy titanium as a catalyst. “BPP” refers to polyoxypropylene-(2,3)-2,2-bis(4-hydroxyphenyl)propane. “BPE” refers to polyoxyethylene-(2,3)-2,2-bis(4-hydroxyphenyl)propane. The amount of the catalyst charged was an amount that made the concentration of the contents of the reaction vessel 150 ppm. Next, the contents of the reaction vessel were stirred using the stirrer. Thereafter, the stirring using the stirrer was continued until synthesis of a non-crystalline polyester resin A was completed. Next, the contents of the reaction vessel were heated up to 265° C. Through the heating, an esterification reaction was caused of the contents of the reaction vessel. Furthermore, water was distilled out of the reaction vessel. Next, the temperature of the contents of the reaction vessel was kept at 265° C. until water was no longer distilled out of the reaction vessel.

Next, the internal pressure of the reaction vessel was reduced to 8.3 kPa while the temperature of the contents of the reaction vessel was reduced to 235° C. The pressure was kept thereafter. Through the above, the contents of the reaction vessel caused a condensation reaction. Furthermore, a polyhydric alcohol was distilled out of the reaction vessel. Thereafter, the temperature of the contents of the reaction vessel was kept at 235° C. until the condensation reaction of the contents of the reaction vessel proceeded and a polyester resin with a desired glass transition point (Tg) (55° C. for the non-crystalline polyester resin A) was produced. Note that the glass transition point of the polyester resin in the reaction vessel was estimated from the torque of the stirrer. Next, the stirrer of the reaction vessel was stopped and a nitrogen gas was introduced into the reaction vessel until the internal pressure of the reaction vessel reached the standard pressure. Next, the reaction vessel was cooled until the temperature of the contents of the reaction vessel reached 100° C. or lower. Thus, a non-crystalline polyester resin A was obtained.

The non-crystalline polyester resin A had a glass transition point of 55° C. The non-crystalline polyester resin A was not determined to have a definite melting point by contrast and was therefore confirmed as non-crystalline.

### [Preparation of Non-crystalline Polyester Resin B]

A non-crystalline polyester resin B was prepared according to the same method as that for preparing the non-crystalline polyester resin A in all aspects other than that the polybasic carboxylic acids and the polyhydric alcohols used were changed to those shown below. In the preparation of the non-crystalline polyester resin B, 50 parts by mole of terephthalic acid, 34 parts by mole of isophthalic acid, 5 parts by mole of naphthalenedicarboxylic acid, and 11 parts by mole of sodium 5-sulfoisophthalate were used as the polybasic carboxylic acids. Furthermore, in the preparation of the non-crystalline polyester resin B, 72 parts by mole of bisphenol A propylene oxide adduct and 28 parts by mole of ethylene glycol were used as the polyhydric alcohols.

The non-crystalline polyester resin B had a glass transition point of 60° C. By contrast, the non-crystalline polyester resin B was not determined to have a definite melting point and was therefore confirmed as non-crystalline.

### <Ink Preparation>

Inks of Examples 1 to 10 and Comparative Examples 1 to 3 were prepared by the following methods.

### Example 1

### (Mixing Kneading and Pulverization)

Using an FM mixer (“FM-10B”, product of Nippon Coke & Engineering Co., Ltd.), 200 parts by mass of the aforementioned non-crystalline polyester resin A and 100 parts by mass of a phthalocyanine pigment 15:3 (“LIONOL (registered Japanese trademark) BLUE FG-73302”, product of TOYO INK CO., LTD., color index: Pigment Blue 15:3) were pre-mixed at a rotational speed of 2000 rpm for 4 minutes to obtain a mixture I. The resultant mixture I was melt-kneaded using a twin screw extruder (“PCM-30”, product of KABUSHIKI KAISHA IKEGAI) under conditions of a melt-kneading temperature (cylinder temperature) of 120° C., a rotational speed of 150 rpm, and a processing speed of 100 g/min. The resultant melt-kneaded product was coarsely pulverized using a pulverizer (“TURBO MILL MODEL TA”, product of FREUND-TURBO CORPORATION) set at a set particle diameter of 6 μm to obtain a kneaded and pulverized product. As described above, in the mixing kneading and pulverization in Example 1, the charge amount ratio (resin/pigment) of the resin (non-crystalline polyester resin A) to the pigment (phthalocyanine pigment) was 2.00/1 and the charge amount ratio (resin/pigment) of a wax to the resin (non-crystalline polyester resin A) was 0.00/1.

### (High-Pressure Emulsification)

Ion exchange water, the aforementioned kneaded and pulverized product, a surfactant (“OLFINE (registered Japanese trademark) E1004”, product of Nissin Chemical Industry Co., Ltd., ethylene oxide adduct of acetylenediol), and a 1M NaOH aqueous solution were mixed to obtain a mixture II. The amount of the 1M NaOH aqueous solution added was 1.05 times the neutralization equivalent of the resin (non-crystalline polyester resin A) contained in the kneaded and pulverized product. The amounts of the ion exchange water, the kneaded and pulverized product, and the surfactant were such that they produced a first dispersion through the high-pressure emulsification with a composition x of described below. In the composition x, the amount of the water indicates a total (X+Y+Z) of the amount (X parts by mass) of the ion exchange water used, the mass (Y parts by mass) of water contained in the 1M NaOH aqueous solution, and the mass (Z parts by mass) of water produced by a neutralization reaction between the resin and NaOH contained in the 1M NaOH aqueous solution. In the composition x, the amount of the kneaded and pulverized product indicates a total (V+W) of the amount (V parts by mass) of the kneaded and pulverized product used and the mass (W parts by mass) of Na⁺ incorporated into the kneaded and pulverized product by the neutralization reaction of the resin.

### (Composition x of First Dispersion)

Water: 69.5% by mass
Kneaded and pulverized product: 30.0% by mass
Surfactant: 0.5% by mass

Using a high-pressure emulsification apparatus (“NANOVATER (registered Japanese trademark) NV-200”, product of Yoshida Kikai CO., LTD.) with a heating system mounted, the mixture II was emulsified five times at a temperature of 140° C. and a processing pressure of 150 MPa. Through the above, the first dispersion was obtained.

### (Centrifugation and Dispersion)

The resultant first dispersion was moved to a vessel, and the vessel was set in a centrifugal adhesion measuring device (“NS-C100”, product of Nano Seeds Corporation). Using the centrifugal adhesion measuring apparatus, the dispersion was centrifugated under a condition of a rotational speed of 5000 rpm over 24 hours. After the centrifugation, the supernatant was removed from the vessel to obtain a precipitate remaining in the vessel. Thereafter, ion exchange water having the same volume as that of the removed supernatant was added into the vessel. In the manner described above, free resin was removed from the first dispersion. As a result, a pigment particle dispersion was obtained. The pigment particle dispersion contained water and pigment particles (solid concentration 30% by mass) dispersed in the water.

### (Measurement of Mass Ratio (Resin/Pigment) and Mass Ratio (Wax/Resin))

With reference to the pigment particles contained in the pigment particle dispersion, the mass ratio (also referred to below as a “ratio (resin/pigment)”) of the resin to the pigment and the mass ratio (also referred to below as a “mass ratio (wax/resin) of the wax to the resin were measured by the following methods. Measurement results are shown below in Tables 1 to 3.

First, a measurement target (the pigment particle dispersion) was charged into a reduced pressure oven. In doing so, the amount of the measurement target charged was taken to be a mass M_{A} [g]. Next, the reduced pressure oven was set at a temperature of 150° C. and a pressure of 0.67 Pa to evaporate the aqueous medium from the measurement target. Through the above, a first solid was obtained. An amount M_{B} of the resin contained in the first solid was measured by gel filtration chromatography (GPC). It is determined that the pigment particle dispersion contained almost no free resin. Therefore, the amount M_{B} of the resin can be regarded as the same as that of the resin contained in the pigment particles.

The amount M_{B} of the resin contained in the first solid, the mass of the pigment, and the mass of the wax were applied to the following formula. Using the formula, the mass ratio (resin/pigment) and the mass ratio (wax/resin) in the pigment particles were calculated. Note that each mass of the pigment and the wax was calculated by multiplying the mass M_{A} [g] of the measurement target by the percentage content of the pigment or the wax in the measurement target. Each percentage content of the pigment and the wax in the measurement target was calculated from the corresponding charge amount.
Mass ratio (resin/pigment)=amount M_{B} of resin contained in first solid/mass of pigment
Mass ratio (wax/pigment)=mass of wax/amount M_{B} of resin contained in first solid

### (Ink Preparation)

A vessel was charged with 60.00 parts by mass of the pigment particle dispersion (amount of pigment: 6.00 parts by mass), 20.00 parts by mass of ethylene glycol, 15.00 parts by mass of diethyl diglycol, 0.30 parts by mass of a surfactant (“OLFINE (registered Japanese trademark) E1004”, product of Nissin Chemical Industry Co., Ltd., ethylene oxide adduct of acetylenediol), and ion exchange water. The amount of the ion exchange water added was an amount (4.70 parts by mass in Example 1) that made the total amount of the vessel contents 100.00 parts by mass. The vessel contents were uniformly mixed by stirring the vessel contents at a rotational speed of 400 rpm using a stirrer (“THREE-ONE MOTOR BL-600”, product of Shinto Scientific Co., Ltd.). The resultant mixed liquid was filtered using a membrane filter (pore size: 5 μm) to obtain an ink of Example 1.

Note that it is determined that the mass ratio (resin/pigment) and the mass ratio (wax/resin) measured for a pigment particle dispersion do not change between before and after ink preparation. Therefore, the mass ratio (resin/pigment) and the mass ratio (wax/resin) measured for the aforementioned pigment particle dispersion were directly regarded as the mass ratio (resin/pigment) and the mass ratio (wax/resin), respectively.

### (Free Resin Measurement)

A “free resin rate” was measured for the ink of Example 1 by the following method. Here, the “free resin rate” refers to a rate of free resin in the ink to the total amount of the free resin and the resin contained in the pigment particles. Measurement results are shown below in Tables 1 to 3.

First, a measurement target (ink of Example 1) was placed into a reduced pressure oven. In doing so, the amount of the measurement target placed was taken to be a mass M_{C} [g]. Next, the reduced pressure oven was set at a temperature of 150° C. and a pressure of 0.67 Pa to evaporate the aqueous medium from the measurement target. Through the above, a first solid was obtained. An amount M_{D} (total amount of free resin and the resin contained in the pigment particles) of the resin contained in the first solid was measured by gel filtration chromatography (GPC).

Separately, the measurement target with a mass of M_{C} [g] was moved to a vessel, and the vessel was set in a centrifugal adhesion measuring apparatus (“NS-C100”, product of Nano Seeds Corporation). Using the centrifugal adhesion measuring apparatus, the measurement target was centrifugated under a condition of a rotational speed of 5000 rpm over 24 hours. After the centrifugation, the supernatant was collected from the vessel. The collected supernatant was charged into a reduced pressure oven. Next, the reduced pressure oven was set at a temperature of 150° C. and a pressure of 0.67 Pa to evaporate the aqueous medium from the supernatant. Through the above, a second solid was obtained. An amount ME (mass of free resin) of the resin contained in the second solid was measured by gel filtration chromatography (GPC).

The amount M_{D} of the resin contained in the first solid and the mass ME of the resin contained in the second solid were applied to the following formula. Using the formula, a free resin rate was calculated.

Free resin rate=100×amount M_{E} of resin contained in second solid/amount M_{D} of resin contained in first solid

### Examples 2 to 10 and Comparative Examples 1 to 3

Inks of Examples 2 to 10 and Comparative Examples 1 to 3 were prepared according to the same method as that for preparing the ink of Example 1 in all aspects other than the following changes. In the preparation of the inks of Examples 2 to 10 and Comparative Examples 1 to 3, the pigment and the type and amount of the resin use in the mixing kneading and pulverization were changed to those shown below in Tables 1 to 3. Note that the pigment used in Example 9 was a quinacridone pigment 122 (“TRM-11”, product of Dainichiseika Color & Chemicals Mfg. Co., Ltd., C.I. Pigment Red 122). In the preparation of Examples 6 to 8, a wax (“NISSAN ELECTOL (registered Japanese trademark) WEP3”, product of NOF CORPORATION, fatty acid ester wax) in amounts indicated below in Table 2 was added in the mixing kneading and pulverization. In the preparation of the inks of Examples 2 to 10 and Comparative Examples 1 to 3, each amount of the kneaded and pulverized product, water, the surfactant, and 1M NaOH used in the high-pressure emulsification was changed to make the composition x of the first dispersion those shown below in Tables 1 to 3.

In Tables 1 to 3 below, the types “15:3” and “122” for the pigments in the column “Mixing kneading and pulverization” refer to phthalocyanine pigment 15:3 and quinacridone pigment 122, respectively. The types “A” and “B” for the resins in the column “Mixing kneading and pulverization” refer to the non-crystalline polyester resin A and the non-crystalline polyester resin B, respectively. Note that the ink preparation was carried out using the first dispersion without carrying out the centrifugation for the ink of Comparative Example 3. The charge amount ratio (resin/pigment) and the charge amount ratio (wax/resin) in the mixing kneading and pulverization were directly regarded as the mass ratio (resin/pigment) and the mass ratio (wax/resin), respectively, for the ink of Comparative Example 3.

TABLE 1

| | | | Example | | | | |
|---|---|---|---|---|---|---|---|
| | | | 1 | 2 | 3 | 4 | 5 |
| Mixing | Pigment | Type | 15:3 | 15:3 | 15:3 | 15:3 | 15:3 |
| kneading and | | Part by mass | 100 | 100 | 100 | 100 | 100 |
| pulverization | Resin | Type | A | A | A | A | A |
| | | Part by mass | 200 | 150 | 250 | 300 | 350 |
| | Wax | Part by mass | — | — | — | — | — |
| | Charge amount ratio (resin/pigment) | | 2.00/1 | 1.50/1 | 2.50/1 | 3.00/1 | 3.50/1 |
| | Charge amount ratio (wax/resin) | | 0.00/1 | 0.00/1 | 0.00/1 | 0.00/1 | 0.00/1 |
| Emulsification | Kneaded and pulverized product | Part by mass | 30.0 | 25.0 | 35.0 | 40.0 | 45.0 |
| Composition x | Water | Part by mass | 69.5 | 74.5 | 64.5 | 59.5 | 54.5 |
| | Surfactant | Part by mass | 0.5 | 0.5 | 0.5 | 0.5 | 0.5 |
| Centrifugation | Centrifugation done/undone | | Done | Done | Done | Done | Done |
| | Mass ratio (resin/pigment) | | 1.88/1 | 1.45/1 | 2.32/1 | 2.70/1 | 3.05/1 |
| | Mass ratio (wax/resin) | | — | — | — | — | — |
| Ink preparation | Pigment particle dispersion | Part by mass | 60.00 | 60.00 | 60.00 | 60.00 | 60.00 |
| | Ethylene glycol | Part by mass | 20.00 | 20.00 | 20.00 | 20.00 | 20.00 |
| | Diethylene glycol | Part by mass | 15.00 | 15.00 | 15.00 | 15.00 | 15.00 |
| | Surfactant | Part by mass | 0.30 | 0.30 | 0.30 | 0.30 | 0.30 |
| | Water | Part by mass | Rest | | | | |
| | Total | Part by mass | 100.00 | 100.00 | 100.00 | 100.00 | 100.00 |
| | Pigment concentration | % By mass | About 6 | About 6 | About 6 | About 6 | About 6 |
| | Free resin rate | % By mass | 2.30 | 2.11 | 2.52 | 2.87 | 2.95 |

TABLE 2

| | | | Example | | | | |
|---|---|---|---|---|---|---|---|
| | | | 6 | 7 | 8 | 9 | 10 |
| Mixing | Pigment | Type | 15:3 | 15:3 | 15:3 | 122 | 15:3 |
| kneading and | | Part by mass | 100 | 100 | 100 | 100 | 100 |
| pulverization | Resin | Type | A | A | A | A | B |
| | | Part by mass | 200 | 200 | 200 | 200 | 200 |
| | Wax | Part by mass | 10 | 6 | 14 | — | — |
| | Charge amount ratio (resin/pigment) | | 2.00/1 | 2.00/1 | 2.00/1 | 2.00/1 | 2.00/1 |
| | Charge amount ratio (wax/resin) | | 0.051 | 0.03/1 | 0.07/1 | 0.00/1 | 0.00/1 |
| Emulsification | Kneaded and pulverized product | Part by mass | 31.0 | 30.6 | 31.4 | 30.0 | 30.0 |
| Composition x | Water | Part by mass | 68.5 | 68.9 | 68.1 | 69.5 | 69.5 |
| | Surfactant | Part by mass | 0.5 | 0.5 | 0.5 | 0.5 | 0.5 |
| Centrifugation | Centrifugation done/undone | | Done | Done | Done | Done | Done |
| | Mass ratio (resin/pigment) | | 1.87/1 | 1.87/1 | 1.85/1 | 1.85/1 | 1.86/1 |
| | Mass ratio (wax/resin) | | 0.049/1 | 0.030/1 | 0.068/1 | 0.00/1 | 0.00/1 |
| Ink preparation | Pigment particle dispersion | Part by mass | 60.00 | 60.00 | 60.00 | 60.00 | 60.00 |
| | Ethylene glycol | Part by mass | 20.00 | 20.00 | 20.00 | 20.00 | 20.00 |
| | Diethylene glycol | Part by mass | 15.00 | 15.00 | 15.00 | 15.00 | 15.00 |
| | Surfactant | Part by mass | 0.30 | 0.30 | 0.30 | 0.30 | 0.30 |
| | Water | Part by mass | Rest | | | | |
| | Total | Part by mass | 100.00 | 100.00 | 100.00 | 100.00 | 100.00 |
| | Pigment concentration | % By mass | About 6 | About 6 | About 6 | About 6 | About 6 |
| | Free resin rate | % By mass | 2.32 | 2.26 | 2.31 | 2.39 | 2.34 |

TABLE 3

| | | | Comparative Example | | |
|---|---|---|---|---|---|
| | | | 1 | 2 | 3 |
| Mixing kneading | Pigment | Type | 15:3 | 15:3 | 15:3 |
| and pulverization | | Part by mass | 100 | 100 | 100 |
| | Resin | Type | A | A | A |
| | | Part by mass | 100 | 400 | 200 |
| | Wax | Part by mass | — | — | — |
| | Charge amount ratio (resin/pigment) | | 1.00/1 | 4.00/1 | 2.00/1 |
| | Charge amount ratio (wax/resin) | | 0.00/1 | 0.00/1 | 0.00/1 |
| Emulsification | Kneaded and pulverized product | Part by mass | 20.0 | 50.0 | 30.0 |
| Composition x | Water | Part by mass | 79.5 | 49.5 | 69.5 |
| | Surfactant | Part by mass | 0.5 | 0.5 | 0.5 |
| Centrifugation | Centrifugation done/undone | | Done | Done | Done |
| | Mass ratio (resin/pigment) | | 0.99/1 | 3.22/1 | — |
| | Mass ratio (wax/resin) | | 0 | 0 | 0 |
| Ink preparation | Pigment particle dispersion | Part by mass | 60.00 | 60.00 | 60.00 |
| | Ethylene glycol | Part by mass | 20.00 | 20.00 | 20.00 |
| | Diethylene glycol | Part by mass | 15.00 | 15.00 | 15.00 |
| | Surfactant | Part by mass | 0.30 | 0.30 | 0.30 |
| | Water | Part by mass | Rest | | |
| | Total | Part by mass | 100.00 | 100.00 | 100.00 |
| | Pigment concentration | % By mass | About 6 | About 7 | About 6 |
| | Free resin rate | % By mass | 1.60 | 3.20 | 5.12 |

### Evaluation

With respect to each of the inks of Examples 1 to 10 and Comparative Examples 1 to 3, ejectability (viscosity) and fixability and preservation stability of formed images were evaluated. Each evaluation was carried out at a temperature of 25° C. and a relative humidity of 60% unless otherwise stated. Evaluation results are shown below in Table 4.

### [Ejectability]

Using a falling ball automatic micro viscometer (“AMVN”, product of Anton Paar Japan K.K.), the viscosity of an evaluation target (any of the inks of Examples 1 to 10 and Comparative Examples 1 to 3) at 25° C. was measured in accordance with the method described in the Japanese Industrial Standards (JIS) Z8803:2011, “Methods for viscosity measurement of liquid”. Ejectability was evaluated according to the following criteria.

### (Criteria of Ejectability)

A (good): viscosity of at least 5.0 mPa·s and no greater than 7.0 mPa·s
B (poor): viscosity of less than 5.0 mPa·s or greater than 7.0 mPa·s

### [Fixability]

In evaluation of fixability, an inkjet printer (prototype produced by KYOCERA Document Solutions Japan Inc.) was used as an evaluation apparatus. The evaluation target (any of the inks of Examples 1 to 10 and Comparative Examples 1 to 3) was loaded into a recording head of the evaluation apparatus. The evaluation apparatus was set so that the volume of the ink to be ejected from the recording head was 10 pL per one drop.

As a recording medium, an A4-size OHP sheet (ESPET (registered Japanese trademark) E5200″, product of Toyobo Co., Ltd., biaxially oriented polyester film, thickness 0.10 mm) was used. Using the evaluation apparatus, a solid image (size: 2 cm by 2 cm, printing rate: 100%) was formed on the recording medium. Next, the recording medium was dried at 80° ° C. for 2 hours using a dryer.

Next, the solid image was fixed to the recording medium at a fixing temperature of 160° C. using a fixing device provided in a multifunction peripheral (“TASKalfa2551ci”, product of KYOCERA Document Solutions Japan Inc.). Next, a rubbing test was carried out on the recording medium.

In detail, a metal weight (in columnar shape with a diameter of 50 mm and a mass of 1 kg) having a bottom covered with fabric was placed on the solid image formed on the recording medium. Thereafter, the solid image was rubbed back and force 10 times with a load of 1 kg applied using the weight. Next, the solid image was visually observed to confirm whether or not the solid image has been peeled off from the OHP sheet. Next, the solid image was further rubbed back and force 40 times (50 times in total) with a load of 1 kg using the weight. Next, the solid image was visually observed to confirm again whether or not the solid image has been peeled off from the OHP sheet. Note that it was determined that the solid image has been peeled off when at least a part of the solid image has been peeled off. Fixability was evaluated according to the following criteria.

### (Criteria of Fixability)

A (very good): The solid image has not been peeled off even after the 50-time back-and-force rubbing.
B (good): The solid image has not been peeled off after the 10-time back-and-force rubbing but has been peeled off after the 50-time back-and-force rubbing.
C (poor): The solid image has been peeled off after the 10-time back-and-force rubbing.

### [Preservation Stability]

The evaluation target (any of the inks of Examples 1 to 10 and Comparative Examples 1 to 3) was put into a transmittance measurement cell (optical path length: 1 mm). The transmittance measurement cell was set in a spectrophotometer (“U-3000”, product of Hitachi High-Tech Science Corporation), and a transmittance spectrum of the measurement target was plotted. From the plotted transmittance spectrum, a transmittance (initial transmittance) of the measurement target at a wavelength of 610 nm was determined.

Next, 30 g of the measurement target was put and sealed into a 50-mL polyethylene vessel and left in a constant temperature bath set at a set temperature of 60° C. for 1 week for preservation. After the preservation, a transmittance (post-preservation transmittance) of the measurement target at a wavelength of 610 nm was determined according to the same method as that for determining the initial transmittance. Using the following formula, a transmittance change rate between before and after the preservation was calculated. The transmittance change rate was taken as an evaluation value for evaluation of preservation stability. Preservation stability was evaluated according to the following criteria.

Transmittance change rate [%]=100×|(initial transmittance−post-preservation transmittance)/initial transmittance|

### (Criteria of Preservation Stability)

A (good): change rate of less than 5%
B (poor): change rate of 5% or more
Note that when preservation stability of an ink is poor, the pigment particles thereof agglomerate and precipitate to increase transmittance.

TABLE 4

| | | Example | | | | | | | | | | Comparative Example | | |
|---|---|---|---|---|---|---|---|---|---|---|---|---|---|---|
| | | 1 | 2 | 3 | 4 | 5 | 6 | 7 | 8 | 9 | 10 | 1 | 2 | 3 |
| Ejectability | Viscosity [mPa · s] | 6.1 | 6.1 | 6.4 | 6.8 | 6.9 | 6.1 | 6.0 | 6.1 | 6.3 | 6.2 | 6.0 | 7.2 | 7.9 |
| | Rating | A | A | A | A | A | A | A | A | A | A | A | B | B |
| Fixability | | B | B | B | B | B | A | A | A | B | B | C | B | B |
| Preservation | Change rate [%] | 0.5 | 0.2 | 1.2 | 2.8 | 4.5 | 0.5 | 0.6 | 0.8 | 0.6 | 0.6 | 0.2 | 5.4 | 7.8 |
| stability | Rating | A | A | A | A | A | A | A | A | A | A | A | B | B |

As shown in Tables 1 to 4, the inks of Examples 1 to 10 each contained pigment particles and an aqueous medium. The pigment particles contained a pigment and a resin. The resin had a mass ratio (mass ratio (resin/pigment)) to the pigment in the pigment particles of at least 1.40 and no greater than 3.10. The resin included a polyester resin. The inks of Examples 1 to 10 each contained free resin and the ratio of the free resin to the total amount of the free resin and the resin contained in the pigment particles was greater than 0.00% by mass and no greater than 3.00% by mass. Each of the inks of Examples 1 to 10 exhibited excellent ejectability and preservation stability and formed images with excellent fixability.

In addition, the pigment particles in the inks of Examples 6 to 8 further contained a wax. As a result, images formed with any of the inks of Examples 6 to 8 were very good in fixability.

By contrast, in the pigment particles in the ink of Comparative Example 1, the mass ratio of the resin to the pigment was less than 1.40. The ink of Comparative Example 1 was determined to be insufficient in fixability of formed images due to the amount of the resin in the pigment particles being insufficient.

In the pigment particles in the ink of Comparative Example 2, the mass ratio of the resin to the pigment was greater than 3.10. In addition, the ink of Comparative Example 2 had a free resin rate of greater than 3.00% by mass. In the ink of Comparative Example 2, the amount of the resin in the pigment particles was excessive and an excessive amount of free resin was contained. Therefore, viscosity was excessively high and preservation stability was insufficient.

The ink of Comparative Example 3 had a free resin rate of greater than 3.00% by mass. The image formed with the ink of Comparative Example 3 contained an excessive amount of the free resin. Therefore, viscosity was excessively high and preservation stability was insufficient.

What is claimed is:

1. An inkjet ink comprising:
pigment particles; and
an aqueous medium, wherein
the pigment particles contain a pigment and a resin,
the resin has a mass ratio to the pigment in the pigment particles of at least 1.40 and no greater than 3.10,
the resin includes a polyester resin,
the inkjet ink does not contain free resin dispersed in the aqueous medium or contains the free resin at a rate to a total amount of the free resin and the resin contained in the pigment particles of greater than 0.00% by mass and no greater than 3.00% by mass.

2. The inkjet ink according to claim 1, wherein
the polyester resin is non-crystalline polyester resin.

3. The inkjet ink according to claim 1, wherein
the pigment particles have a percentage content of at least 7.0% by mass and no greater than 30.0% by mass.

4. The inkjet ink according to claim 1, wherein
the pigment particles further contain a wax.

5. The inkjet ink according to claim 4, wherein
the wax has a mass ratio to the resin in the pigment particles of at least 0.01 and no greater than 0.10.

6. An inkjet ink production method comprising:
mixing and kneading a pigment and a resin to obtain a kneaded product;
pulverizing the kneaded product to obtain a kneaded and pulverized product;
performing high-pressure emulsification treatment on the kneaded and pulverized product to obtain a dispersion;
centrifugating the dispersion to obtain a precipitate; and
dispersing the precipitate in an aqueous medium to obtain a pigment particle dispersion containing pigment particles, wherein
the resin includes a polyester resin, and
the resin has a mass ratio to the pigment in the pigment particles of at least 1.40 and no greater than 3.10.
